(19) United States
(12) Patent Application Publication
(10) Pub. No.: US 2007/0239589 A1
(43) Pub. Date: Oct. 11, 2007

(54) Interest rate derivative financial product

(76) Inventors: Donald R. Wilson JR., Chicago, IL (US); Dominic M. Cairo, Chicago, IL (US); David J. Hrencecin, Chicago, IL (US); Richard L. West, Chicago, IL (US)

Correspondence Address: Paul E. Schaafsma;NovusIP, LLC, Suite 221, 521 West Superior Street, Chicago, IL, 60610-3135, US

(21) Appl. No.: 11/394,465

(22) Filed: Mar. 31, 2006

(51) Int. Cl. G06Q 40/00

(52) U.S. Cl. 705/37

(57) ABSTRACT

In accordance with the principles of the present invention, a standardized contract is traded. The contract obligates a buyer and a seller to settle the contract based on a price determined for an effective date. The contract is traded over-the-counter or through an exchange and cleared by a clearinghouse that guarantees payment to the buyer of any amount owed to the buyer from the seller as a result of the contract and that guarantees payment to the seller of any amount owed to the seller from the buyer as a result of the contract. An over-the-counter or exchange traded instrument is utilized to determine the rate that is used to determine the price of the contract.

### FIELD OF THE INVENTION

The present invention relates to interest rate derivative financial products.

### BACKGROUND OF THE INVENTION

A variety of different types of contracts are traded on various commodity exchanges and other markets throughout the world. A cash contract is a sales agreement for either immediate or deferred delivery of the actual commodity. A derivatives contract is a financial instrument whose value is linked to the price of an underlying commodity, asset, rate, index or the occurrence or magnitude of an event. Typical examples of derivatives contracts include futures, forwards, swaps, and options, and these can be combined with traditional financial instruments and loans in order to create structured financial instruments that are also known as hybrid instruments.

First introduced a half century ago, an interest rate swap is a well-known financial transaction typically occurring between two parties. In a swap, the two parties agree to make payments to each other; the payments of the first and second parties define the type of swap. In a basis swap, the payments made by the first and second parties are based on different floating interest rates in the same currency. In a currency swap, the payments are made based on either fixed and/or floating interest rates in different currencies. In an interest rate swap, the payments made by the parties are in the same currencies, but one of the payments is based on a fixed interest rate while the other payment is based on a floating interest rate. The two parties to the interest rate swap are called counterparties.

One purpose of an interest rate swap is as a hedge from changing interest rates; however, such hedge results in an added cost. In an interest rate swap, while one party is often hedging against potential losses, the other party is often seeking financial gain based on speculation that the added cost paid by the hedging party will be greater than the actual change in value due to the interest rate change.

The payments made between the parties in an interest rate swap are based on interest rates; however, the interest rate is only one factor in determining the amount of payment. Another factor is the amount of principal which is periodically multiplied by the different interest rates to determine the payments made. In an interest rate swap, there is no exchange or payment of principal, so the principal is referred to as being a notional amount. This notional amount dictates the size of the interest payments and is agreed on by the parties when negotiating the terms of the interest rate swap. The notional amount remains constant for the duration of the swap.

For example, an exemplary interest rate swap could be between a first dealer (for example, a typical bank which is relatively small in size) which desires to reduce the risk of interest rate fluctuation and a second dealer (for example, a large financial institution) which is willing to accept a risk in interest rate fluctuation in return for receiving a higher fixed interest rate. The first dealer agrees to pay the second dealer interest payments that are based on a long term fixed rate. In exchange, the second dealer agrees to pay the first dealer interest payments that are based on a short term floating rate. Thus, the first dealer and the second dealer are counterparties.

Typically, the floating interest rate is tied to the London Interbank Offered Rate (LIBOR), which is the rate of interest at which banks can borrow funds from other banks, in marketable size, in the London Interbank market and is set by the British Bankers' Association, Pinners Hall, 105-108 Old Broad Street, London EC2N 1EX United Kingdom, a trade association representing banks and other financial services firms that operate in the United Kingdom. If the first dealer and the second dealer enter into a swap over a longer-term period (for example five (5) years), the first dealer pays out interest to the second dealer according to the fixed rate over that period (e.g. five years at the five-year fixed rate) and receives interest from the second dealer according to a floating shorter-term rate (for example, the three-month LIBOR rate) over that same period. Conversely, the second dealer receives interest payments from the first dealer according to the fixed long-term rate and pays interest payments to the first dealer based on the floating short-term rate. Both the fixed long-term rate and the LIBOR rate are applied to a common notional principal. Alternatively, both series of cash flows could be based on different floating interest rates, that is, variable interest rates that are based upon different underlying indices. This type of interest rate swap is known as a basis or a money market swap.

Before entering into an interest rate swap contract, the first dealer and the second dealer may try to value the price of the interest rate swap. The value of an interest rate swap is the difference between the net present value of the two future income streams that are swapped by the first dealer and the second dealer. Because the floating interest rate varies in the future, the size of each future cash flow based on the floating interest rate is not known to either the first dealer or the second dealer. To solve this problem, the swap market uses forward implied interest rates to estimate the net present value of the fixed and floating interest rates. The forward interest rates may be derived from convexity adjusted Eurodollar Futures rates for example, or benchmark swap rates promulgated by the International Swap Dealers Association (ISDA) 360 Madison Avenue, 16th Floor, New York, N.Y. 10017 USA, a global trade association representing participants in the privately negotiated derivatives industry. The ISDA also provides a legal master documentation for interest rate swap transactions (available at http://www.isda.org/cl.html). ISDA agreements are essential for each new counterparty, and amendments to agreements are required for each new deal with a particular counterparty.

Thus, an interest rate swap is effectively a construction of two cash flow streams with the same maturity. In a “vanilla” fixed for floating interest rate swap one of the cash flow streams is comparable to that of a bond (fixed interest rate payments) and the other cash flow stream is comparable to a periodically revolving borrowing/lending facility or floating rate note (floating interest rate payments). Mathematical analysis shows that the net present value of an interest rate swap has interest rate sensitivity similar to the price of a bond having a similar coupon, maturity, and credit rating.

The similarities between in the interest rate sensitivities of “vanilla” interest rate swaps and bonds explains the heavy use of government bond futures, government bond repos, and the cash market to manage interest rate risk resulting out of interest rate swap transactions; this practice, however, also involves disadvantages. Initially, both market segments are based on different credits and therefore an unexpected change in the yield differential of the two markets could result in heavy losses. In addition, conventional techniques require efficient access to the bond and repo market. Specifically, repo transactions can be problematic since these transactions have to be renegotiated on a regular basis and market conditions can be volatile.

The interest rate swap market is, by some measures, the largest sector of the global fixed income market. Despite the size of the interest rate swap market, barriers to entry exist for new, and sometimes existing, participants. Even utilizing ISDA agreements, each transaction is a separately negotiated contract with little standardization of financial terms. The contracts are lengthy and complex, and legal review is required for each transaction. Hence, any large and sophisticated user must endure the overhead burdens associated with the conventional, inefficient operating environment of the interest rate swap market.

Within the interest rate swap market, bilateral netting agreements facilitate netting of positions between specific counterparties by reducing credit exposure and freeing up capital; however, it is difficult, if not impossible, for participants to freely net deals across multiple counterparties. Further, it is time consuming and cumbersome to settle each agreement separately, and there is no guarantee that the cancellation or assignment of a particular contract provides the best price.

The users of the interest rate swap market are, in essence, all organizations who are exposed to interest rate risk. This can include for example banks, state treasuries, supranational organizations, insurance companies, investment funds, large corporations, and increasingly small and medium sized corporations. The major participants and liquidity providers in the interest rate swap market are global banks which are able to manage interest rate risk and efficiently administer the vast number of interest rate swap transactions.

The various barriers to entry into the interest rate swap market have resulted in a heavy concentration of business among a handful of the largest global banks. This oligopolistic environment has led to an artificial lack of market transparency (since each transaction is unique and proprietary to the counterparties) and the discrimination of many market participants who would benefit from more direct access to the interest rate swap market. Large and sophisticated users of interest rate swaps (for example, large corporations) must often operate at a pricing disadvantage to the large global banks with whom they must conduct their business.

An early attempt to eradicate some of the problems that exist in the interest rate swap market occurred in the 1980's, when the Chicago Board of Trade (CBOT), 141 West Jackson Blvd, Chicago, Ill. 60604 USA introduced a product that sought to replicate the interest rate sensitivity of an interest rate swap by applying the product design of short-term interest rate instruments, that is, 100 minus the interest rate swap rate of a predefined maturity. However, the CBOT product exhibited considerable design problems and received little customer support.

In March 2001, the London International Financial Futures and Options Exchange (LIFFE) introduced a swap futures contract called Swapnotes™. According to LIFFE's website (http://www.euronext.com/trader/swaps/0,4860,1732_{—}200505500,00.html accessed on 30 Mar. 2006), Swapnotes™ are offered under a license to U.S. Pat. No. 6,304,858 titled “Method, System, and Computer Program Product for Trading Interest Rate Swaps.” LIFFE is owned by Euronext, Euronext N.V., Beursplein 5, 1012 JW Amsterdam, the Netherlands, and with LIFFE located at Cannon Bridge House, 1 Cousin Lane, London EC4R 3XX, United Kingdom.

This swap contract described in U.S. Pat. No. 6,304,858 is based on the creation of an array of notional cash flows that are discounted to a predefined date by the interest rate swap curve of a particular currency. (Column 3, lines 60-64). The price of the contract is determined based on preselected notional cash flows discounted by an interest rate swap curve obtained from a preselected swap rate source. The interest rate swap curve is a sequence of interest rate swap rates, ordered by term to maturity, obtained from the preselected swap rate source. The swap rate source is LIBOR for interest rates less than one year and is the ISDA Benchmark Swaps rate for interest rates one year or more. In the preferred embodiment, the swap rate curve is defined by LIBOR at 3, 6 and 9 months and by the ISDA Benchmark Swaps Rate at 1, 2, 3, 4, and 5 years. (Column 7, lines 12-20; column 9, lines 24-28).

The actual settlement prices are determined with a pricing model. Thus, futures contracts that are priced according to the pricing model represent agreements to purchase or sell an interest rate swap at a future date called the effective date or settlement date. (Column 8, lines 61-65). The model price is the net present value of a stream of future notional cash flows, in which each individual notional cash flow is discounted by the respective discount factor, constructed from the interest rate swap curve for the last day of trading, that is applicable to the term to maturity over which the individual notional cash flow is received (for example, at the end of 1 year, at the end of 2 years, at the end of 3 years, etc.).

In October 2001, the CBOT introduced a 10 year swap futures contract. It subsequently added 5-Year Swap Futures, 5-Year Swap Futures Options, and 10-Year Swap Futures Options. These contracts are cash settled and based on ISDA benchmark rates for U.S. dollar interest rate swaps. With respect to the 10-Year Interest Rate Swap Futures, for example, the trading unit is the notional price of the fixed-rate side of a notional 10-year interest rate swap. The notional 10-year interest rate swap has a notional principal equal to $100,000. The notional 10-year interest rate swap also exchanges semiannual interest payments at a fixed rate of 6% per annum for quarterly floating interest rate payments that are based on 3-month LIBOR and that otherwise conform to the terms prescribed by the ISDA for the purpose of computing the daily fixing of ISDA Benchmark Rates for U.S. dollar interest rate swaps. The additional CBOT swap futures contracts are likewise structured.

The CBOT interest rate swap futures calculate the settlement value based on the following:
NV*[R/r+(1−R/r)*(1+0.01*r/P)^{-N}]
where NV is the nominal value of the underlying swap (in dollars);
r is the ISDA Benchmark for the last day of trading (in percent per annum);
R is the fixed interest rate of the underlying notional interest rate swap (in percent per annum);
P is the number of scheduled fixed interest payments per year of the underlying notional interest rate swap; and
N is the total number of scheduled fixed interest payments of the underlying notional interest rate swap.
   Thus, for example, for the 10-Year Swap Futures:
   $100,000*[6/r+(1−6/r)*(1+0.01*r/2)⁻²⁰]
   where r is the ISDA Benchmark for the last day of trading. Thus, the design of the CBOT swap contract gives it pricing characteristics that are similar to an actual interest rate swap, assuming that the swap rate does not stray too far from 6%.

In April 2002, the Chicago Mercantile Exchange (CME), 30 South Wacker Drive, Chicago, Ill. 60606 USA introduced 2-year, 5-year, and 10-year swap futures contracts. The CME contracts are cash settled and based on ISDA benchmark rates for U.S. dollar interest rate swaps. The CME contract settlement price is based on a rate index (100 minus the swap rate), similar to Eurodollar futures. With r =ISDA swap rate, the final futures settlement prices are given by:
CME Price =100−r
The value of a full point for the CME contract is $10,000, or a constant $100 per basis point (the contracts trade in quarter basis point increments worth $25 each). Because the CME contracts do not have the nonlinear positively convex price-yield relationship of actual swaps, the futures should price at slightly higher yields than the underlying forward swap yields. Thus, the CME contract is specific to the ISDA consensus settlement and so its use is limited to hedging specific details of the ISDA contract. In addition, the CME contract is relatively static as it is tied into the ISDA consensus settlement which is published once a day. In addition, the ISDA consensus settlement is a consensus of a spot and not a forward price.

Thus, what is needed are swap contracts or other derivatives that are more capable of hedging individual forward rates. It would be further desirable to provide a less static swap contract than the CME or other less static derivatives. In addition, it would be further desirable to provide a swap contract or other derivatives tied to a forward price. It would be further desirable to provide a swap contract or other derivatives that could be more reliant on the selected short instrument. It would be further desirable, in a contract or other derivative, to allow the true variable tick sizes of a swap instrument. It would be further desirable, in a contract or other derivative, to allow the true variable deviation of the minimum fluctuation of the price of the swap instrument. It would be further desirable, in a contract or other derivative, to allow more variation of rate setting schedules and cash flow dates of a swap instrument. It would be further desirable to provide Eurodollar futures market makers and the hedging community a means to create additional liquidity while reducing risk in the back month Eurodollar futures contracts. It would be further desirable to minimize interpolation risk, enable forward curve hedging, allow better pack and bundle hedging, and create exclusive money market exposure.

### SUMMARY OF THE INVENTION

A financial instrument in accordance with the principles of the present invention allows the true variable tick sizes of a swap instrument. A financial instrument in accordance with the principles of the present invention allows the true variable deviation of the minimum fluctuation of the price of the swap instrument. A financial instrument in accordance with the principles of the present invention allows more variation of rate setting schedules and cash flow dates of a swap instrument. A swap futures contract in accordance with the principles of the present invention allows for an Actual/360 timing of cash flows. A swap futures contract in accordance with the principles of the present invention provides Eurodollar futures market makers and the hedging community a means to create additional liquidity while reducing risk in the back month Eurodollar futures contracts. A swap futures contract in accordance with the principles of the present invention minimizes interpolation risk, enables forward curve hedging, allows better pack and bundle hedging, and creates exclusive money market exposure.

In accordance with the principles of the present invention, a standardized contract is traded. The contract obligates a buyer and a seller to settle the contract based on a price determined for an effective date. The contract is traded over-the-counter or through an exchange and cleared by a clearinghouse that guarantees payment to the buyer of any amount owed to the buyer from the seller as a result of the contract and that guarantees payment to the seller of any amount owed to the seller from the buyer as a result of the contract. An over-the-counter or exchange traded instrument is utilized to determine the rate that is used to determine the price of the contract.

### BRIEF DESCRIPTION OF THE DRAWINGS

FIG. 1 shows a scatter plot, with a particular type of swap contract term structure, where the x coordinate is the swap coupon generated from a convexity adjustment derivation method of the present invention, and the y coordinate is the market observed swap coupon.

FIG. 2 shows a horizontal distance from the scatter plot points of FIG. 1 to the y=x line.

FIG. 3 shows a plot of the \vec{cvx} vector resulting from the assumed functional form fit.

FIG. 4 shows the Notional/Year adjusted tick values, for IMM swap contracts with the prices determined by 100-coupon, with discount curves calculated from (raw) futures prices and convexity adjusted futures prices.

FIG. 5 shows tick values obtained from the 100-yield contract price definition.

### DETAILED DESCRIPTION OF THE PREFERRED EMBODIMENTS

In accordance with the principles of the present invention, a swap futures contract is provided. While the particular example swap futures contract described herein can be traded on the International Money Market, which is a division of the Chicago Mercantile Exchange, the principles of the present invention can be applied to any forum in which financial instruments are traded, including but not limited to a designated contract market, a derivatives transaction execution facility, an electronic trading facility, an exempt board of trade, or any future such facility. In addition, when used herein the term swap is not limited to standard “vanilla” interest rate swaps but is intended to apply to all derivative products. International Money Market swaps are heavily traded in dealer markets and have a unique money market convention that give them a precise relationship with a weighted strip of Eurodollar futures. Prior art forward swap contracts do not allow for the Actual/360 timing of cash flows.

A swap futures contract in accordance with the principles of the present invention provides Eurodollar market makers and the hedging community a means to create additional liquidity while reducing risk in the back month Eurodollar contracts. This can be done via bootstrapping currently liquid markets with a swap futures contract in accordance with the present invention to provide accurate, precise pricing to less liquid bundles and packs.

Technical benefits of a swap futures contract of the present invention versus semi-annual 30/360 swap futures include minimal interpolation risk, forward curve hedging, better pack and bundle hedging, and exclusive money market exposure. With respect to minimal interpolation risk, since rate setting dates for the floating interest rates occur on Eurodollar futures expirations and the resulting cash flows coincide with the forward three month London Interbank Offered Rate (LIBOR) cash flow schedule; hence, with a swap futures contract of the present invention there are no date mismatches between the tools used to create the yield curve (bootstrapped strip of Eurodollar futures) and the nominal cash flow dates of the swap. The lack of date mismatches reduces the interpolation risk associated with discounting the future cash flows from an interpolated yield curve.

With respect to forward curve hedging, hedging a swap with a weighted strip of Eurodollar futures requires bucketing the Eurodollar rate sensitivities according to their maturity length and forward yield. With a swap futures contract of the present invention, the risk buckets match with the Eurodollar pieces by maturity, and the forward yields can be bootstrapped from the Eurodollar curve with precise relationships.

With respect to better pack and bundle hedging, with an example swap futures of the present invention, the fixed and floating day count conventions are Actual/360, so the number of years between certain floating cash flows is consistent with the number of years between the fixed cash flows corresponding to the same date range. This consistency allows for better use of packs and bundles as non-granular hedging tools, because packs and bundles share the Actual/360 convention and have similar sensitivities. The prior art swap fixed legs mimic the 30/360 nature of the bond market, and hence bonds are a better non-granular hedging tool.

And with respect to exclusive money market exposure, an example swap futures contract of the present invention provides an Actual/360 day count convention swap future contract that allows a market participant to gain swap exposure without having to leave the money market valuation, risk, and hedging framework.

A swap futures contract in accordance with the principles of the present invention provides some combination of fixed and floating payments where any fixed rate(s) is(are) determined at the trading of the contract and any floating rate(s) is(are) determined at some time in the future. In one embodiment, a swap futures contract in accordance with the principles of the present invention provides an Actual/360 day count convention, with cash flows in accordance with a longer-term fixed interest rate, and cash flows in accordance with a shorter-term floating interest rate. By longer-term fixed interest rate, what is meant is that the rate is fixed for a period of time that is longer than the floating rate period of time; by shorter-term floating interest rate, what is meant is that the term corresponding to the fixed rate is broken up into subintervals of time for which a rate is set at the beginning of each subinterval. In one embodiment, the floating interest-rate is LIBOR, the floating interest rates are set on Eurodollar future expiration dates, and the cash flow dates are Eurodollar value dates. Other floating rate indices such as the European Interbank Offered Rate (EURIBOR), the Tokyo Interbank Offered Rate (TIBOR), the ISDAFIX published prices or another rate index could be utilized. Cash flow dates can be Eurodollar value dates; although value dates and rate setting schedules associated with other floating rate indices could be utilized.

A swap futures contract in accordance with the principles of the present invention provides as its specification potential quote types that can include 100-yield, 100-coupon, and bond price (as a percentage of par). The future bond price can be equal to the future value of notional cash flows, which can be calculated as:
(100%/N)(N*DFₙ+ΣN*C*Tᵢ*DFᵢ)
where N is the notional; C is the coupon; Tᵢ is the time in Actual/360 years corresponding to each coupon payment period; and each DFᵢ is the discount factor corresponding to the time period from the beginning of the swap effective date to the payment date of each coupon. Simplified:
100%*(DFₙ+C*ΣTᵢ*DFᵢ)

In one embodiment, a swap futures contract in accordance with the principles of the present invention can comprise an Actual/360 day count convention with annual fixed cash flows, and quarterly floating interest-rate cash flows. In this embodiment, the floating interest rate can be set to the three month LIBOR rate on Eurodollar expiration dates and the cash flow dates can be Eurodollar value dates. Examples of potential quote types can be 100-Yield, 100-Coupon. For example, the future bond price (FBP) can be derived in accordance with coupon and bond price (as a percentage of par). As previously noted, the future bond price (FBP) can be the future value of notional:
FBP=100% *(DFₙ+ΣC*Tᵢ*DFᵢ)
where coupon (C) is an annually compounded rate;
years between (Tᵢ) can be defined as the actual number of days between two fixed cash flow dates, divided by 360 to convert to “years”; and
future discount factor (DFᵢ) converts each cash flow to the corresponding future value on the swap effective date.
   Fixed cash flow dates can occur annually (every 4^{th} Eurodollar value date from the starting value date) and forward discount factors can be created by bootstrapping the convexity adjusted Eurodollar futures rates beginning with the swap effective date. The swap effective date can be originally defined as the value date of one of the available Eurodollar contracts in the March quarterly cycle, which is currently defined as the day two business days after the LIBOR fixing (e.g. Wednesday after the 3^{rd} Monday in the month).

The Net Present Value (NPV) of a swap, receiving the first cash flow stream and paying the second cash flow stream, is defined as:
NPV=PV_{CashFlowSream1}−PV_{CashFlowStrem2}
One example of this basic swap structure is the fixed for floating interest rate swap. In this structure the cash flow stream 1 and cash flow stream 2 can be replaced by fixed cash flows (Fixed) and floating cash flows (Floating):
NPV=PV_{Fixed}−PV_{Floating}
Where PV_{Fixed} is the sum of present valued fixed cash flows (this is the forward present value, where cash flows are discounted to the swap effective date); and PV_{Floating} is the sum of present valued floating cash flows. If the NPV is defined as zero at swap setting, then:
PV_{Fixed}=PV_{Floating}
Substituting the following for PV_{Fixed}:

$$N * C * ( {\sum }_{i = 1}^{n / p} {DF}_{( p * i )} * {T}_{i} )$$

where N is the notional principal amount; C is a coupon; DFᵢ is the price of a zero coupon bond calculated from the swap effective date to date (i); Tᵢ is the number of years between fixed cash flow date (i-1) and date (i); n is the number of quarters (or another time interval) in the swap; and p is the ratio of the fixed to floating payment periods in quarters (or another time interval), and further substituting the following for PV_{Floating}:

$$N * ( {\sum }_{j = 1}^{n} {F}_{j} * {DF}_{j} * {t}_{j} )$$

where Fⱼ is the forward rate from time (i-1) to time (j) and tᵢ is the number of years, according to the day count convention, between futures value date (j-1) and date(j) gives:

$$N * C * ( {\sum }_{i = 1}^{n / p} {DF}_{( p * i )} * {T}_{i} ) = N * ( {\sum }_{j = 1}^{n} {F}_{j} * {DF}_{j} * {t}_{j} )$$

Solving for the coupon (C):

$$C = \frac{( {\sum }_{j = 1}^{n} {F}_{j} * {DF}_{j} * {t}_{j} )}{( {\sum }_{i = 1}^{n / p} {DF}_{( p * i )} * {T}_{i} )}$$

and substituting the convexity adjustment from future to forward rate for the jth future (cvxⱼ) for the forward rate from time (j-1) to time (j) (Fⱼ) gives:

$$C = \frac{( {\sum }_{j = 1}^{n} ( {f}_{j} + {cvx}_{j} ) * {DF}_{j} * {t}_{j} )}{( {\sum }_{i = 1}^{n / p} {DF}_{( p * i )} * {T}_{i} )}$$

Where fⱼ is 100 minus the futures price spanning time (j-1) to time (j).

A general formulation assumes that the forward rates are derived from the same rates that make up the discount factors, and that the forward rates are consecutive. If these two conditions hold, then the sum of the present valued floating rate cash flows plus a principal repayment is equal to a floating rate note, which is by definition equal to par.

$$Par = ( 100 \% / N ) * ( N * ( {\sum }_{j = 1}^{n} {F}_{j} * {DF}_{j} * {t}_{j} ) + N * {DF}_{n} )$$

$$1 = Par / 100 \% = ( {\sum }_{j = 1}^{n} {F}_{j} * {DF}_{j} * {t}_{j} ) + {DF}_{n}$$

$$N * C * ( {\sum }_{i = 1}^{n / p} {DF}_{( p * i )} * {T}_{i} ) + N * {DF}_{n} = N * ( {\sum }_{j = 1}^{n} {F}_{j} * {DF}_{j} * {t}_{j} ) + N * {DF}_{n}$$

$$C * ( {\sum }_{i = 1}^{n / p} {DF}_{( p * i )} * {T}_{i} ) + {DF}_{n} = 1$$

$$C = \frac{1 - {DF}_{n}}{( {\sum }_{i = 1}^{n / p} {DF}_{( p * i )} * {T}_{i} )}$$

Several methods of applying discount factors in accordance with the principles of the present invention can be applied which are non-limitingly referred to herein as the bond price method, the coupon method, and the yield method. Bootstrapping of a zero (DF) curve from forward rates can be done in accordance with:

$${DF}_{n} = {\prod }_{j = 1}^{n} \frac{1}{1 + {F}_{j} * {t}_{j}}$$

where DFₙ is the price of a zero coupon bond indexed by n; n is the total number of quarters in the term of the zero coupon bond; Fⱼ is the forward rate from time (j-1) to time (j); and tᵢ is the number of years between futures maturity date (j-1) and date (j). In the traditional bootstrapping of a zero (DF) curve from futures rates, prices are only discounted to the first Eurodollar value date; this is because the swap contracts use forward coupons, and the forward swaps start on the first Eurodollar value date. Thus, for ease of use with Eurodollars, there is no stub rate period, and the discount factors can be simply derived from the bootstrapped convexity adjusted futures rates (implied forward rates).

$${DF}_{n} = {\prod }_{j = 1}^{n} \frac{1}{1 + ( {f}_{j} + {cvx}_{j} ) * {t}_{j}}$$

In the bond price method, the contract price is the par bond value in percentage of notional (BV). The total present dollar value of a bond with coupon C and payment frequency every p quarters (TPV) is defined as:
TPV=PV_{Fixed}+N*DFₙ
Where PV_{Fixed} is the sum of present valued fixed cash flows; N is the notional principal amount; DFₙ is the price of a zero coupon bond indexed by n; and Tₙ is the number of years between fixed cash flow date (n-1) and date (n). Substituting:

$$N * C * ( {\sum }_{i = 1}^{n / p} {DF}_{( p * i )} * {T}_{i} )$$

for PV_{Fixed} gives:

$$TPV = N * ( C * ( {\sum }_{i = 1}^{n / p} {DF}_{( i * p )} * {T}_{i} ) + {DF}_{n} * {T}_{n} )$$

Dividing by the notional principal amount (N) gives the contract price as the par bond value in percentage of notional (BV):

$$BV = \frac{TPV}{N} = C * ( {\sum }_{i = 1}^{n / p} {DF}_{( i * p )} * {T}_{i} ) + {DF}_{n} * {T}_{n}$$

In the coupon method the contract price is 100 less the coupon (C). The change of the sum of the present valued fixed cash flows (the forward present value, where cash flows are discounted to the swap start date) (ΔPV_{Fixed}) is defined as:

$$Δ {PV}_{Fixed} = N * Δ C * ( {\sum }_{i = 1}^{n / p} {DF}_{( p * i )} * {T}_{i} ) * \frac{mf}{pf}$$

where N is the notional principal amount; ΔC is the change of the coupon; DF_{τ} is the price of a zero coupon bond indexed by τ; Tₙ is the number of years (using an Actual/360 or other day count) between fixed cash flow date (i-1) and date (i); n is the number of total quarters in swap; p is the ratio of fixed to floating payment periods in quarters; mf is the minimum fluctuation; and pf is the point fluctuation.

The tick size naturally varies according to the sum product of DF and T vectors. Since each DF value˜1 and the IT values˜years in the swap, then

$${\sum }_{i = 1}^{n / p} {DF}_{( p * i )} * {T}_{i} ∼$$

years. Thus the tick size for a 5 year swap would be approximately 5 times the tick size of a 1 year swap. To scale the tick sizes, the notional value should be divided by the number of integer years Y in the contract definition:

$$Δ {PV}_{Fixed} = \frac{N}{Y} * Δ C * ( {\sum }_{i = 1}^{n / p} {DF}_{( p * i )} * {T}_{i} ) * \frac{mf}{pf}$$

If ΔC=pf, and it is roughly assumed that

$$( {\sum }_{i = 1}^{n / p} {DF}_{( p * i )} * {T}_{i} ) \text{/} Y ∼ 1 ,$$

then the tick size should be roughly

$$\frac{Δ {PV}_{Fixed}}{tick} = N * mf ;$$

where N˜$1000000, and mf˜0.000025 (¼ of a basis point), then the

$$\frac{Δ {PV}_{Fixed}}{tick} ∼ \$25 .$$

In the yield method the contract price is 100 less the yield (annual in International Money Market examples) (y). The present valued fixed cash flows (the forward present value, where cash flows are discounted to the swap effective date) (PV_{Fixed}) is defined as:

$${PV}_{Fixed} = N * C * ( {\sum }_{i = 1}^{n / p} \frac{{T}_{i}}{{( 1 + y * ( \frac{g}{4} ) )}^{i}} )$$

Where N is the notional principal amount; C is the coupon; Tₙ is the number of years between fixed cash flow date (i-1) and date (i); n is the number of total quarters in the swap; and p is the ratio of the fixed to floating payment periods in quarters; p=(g/h) where g is the number of fixed payments per annum, and h is the number of floating payments per annum. Taking the derivative of (PV_{Fixed}):

$$\frac{\partial ( {PV}_{Fixed} )}{\partial y} = N * C * ( {\sum }_{i = 1}^{n / p} \frac{- i * ( \frac{g}{4} ) * {T}_{i}}{{( 1 + y * ( \frac{g}{4} ) )}^{i + 1}} ) * \frac{mf}{pf}$$

Where mf is the minimum fluctuation; and pf is the point fluctuation.

Most of the variables are known at the time of the trade, except the proper coupon price and the discount factors. There are several ways to deal with this, and each creates a new type of contract in accordance with the present invention. These are non-limitingly referred to “fixing the coupon”, “transparently valuing the discount curve”, “converting into hedge ratios”, “transparently valuing the convexity adjustment”, and “fixing the tick size”.

In “fixing the coupon”, a moot contract price is created, but if the contract price is changed to be equal to 100-f(\vec{DF}), then only the discount factors are left as a variable. This is the method described in “yield method” above. To “transparently value the discount curve” would require a method for transparently valuing the forward rate curve. An example method is to calculate fair zero coupon prices from the ISDAFIX published rates and Eurodollar prices. ISDAFIX is a benchmark for fixed rates on interest rate swaps promulgated by the International Swaps and Derivatives Association, Inc. 360 Madison Avenue, 16th Floor, New York, N.Y. 10017 USA in co-operation with Reuters news agency, Three Times Square, New York, N.Y. 10036 USA and ICAP plc. interdealer broker, Harborside Financial Center, 1100 Plaza Five, 12th Floor, Jersey City, N.J. 07311 USA.

In “converting into hedge ratios”, the coupon value and the discount factors are related into a “Hedge Ratio”, and so reduce the variables to one. In this example, the contract would trade based on 100-Coupon, but once the contract trades the counterparties receive instead long or short weighted Eurodollar bundle positions, or a different contract or combination of contracts, according to the recent Eurodollar curve, options prices, and other market data. The “Hedge Ratio” can be typically valued by a Taylor series polynomial reconstruction of the original price derivatives matched with some combination of hedging instrument derivatives.

In “transparently valuing the convexity adjustment”, an acceptable convexity adjustment is created thus collapsing the coupon and discount factors into a single variable. This method allows the coupon to be calculated at any moment from the underlying Eurodollar strip, and effectively determines the coupon price.

In “fixing the tick size”, the contract would be market settled, and the lack of a black box would make it transparent. The discount factor variable is transferred from the exchange's settlement price engine to the risk exposure variable of the trader—the burden of evaluating the tick size now is on the trader. Market participants would buy or sell blocks of risk, fixed to a convenient tick size ($5 for example). If the tick size is small enough, traders should be able to achieve their desired swap exposure. In order to maintain price integrity, the contract would have to be either consensus settled, settled with a delivery of the underlying, or settled into a proxy of the underlying.

As is known in the art, a swap futures contract in accordance with the principals of the present invention can be preferably embodied as a system cooperating with computer hardware components, and as a computer-implemented method.

### EXAMPLE

An example basic International Monetary Market (IMM) contract specification in accordance with the principles of the present invention is set for in Table 1, below:

TABLE 1
Example Basic Contract Specification

| | | | | | Min | Tick |
|---|---|---|---|---|---|---|
| Length | Product and Trading Unit | Notional | Listings | Point Size | Fluctuation | Value |
| 1 Yr | IMM Swap Future − Annual | $1,000K | Two | Point Size = | Minimum | Variable |
| | Fixed and Quarterly Floating | | months in | 0.01 = | Fluctuation = | |
| | Payments (LIBOR). Actual/360 | | the March | variable | 0.0025 = | |
| | Day Count Convention. Rate | | quarterly | dollars | variable | |
| | Setting Dates coincide with | | cycle. | | dollars | |
| | Eurodollar Expiration Dates. | | | | | |
| | Cash Flow dates coincide with | | | | | |
| | Eurodollar Value Dates. Cash | | | | | |
| | Settled. | | | | | |
| 2 Yr | IMM Swap Future − Annual | $500K | Two | Point Size = | Minimum | ″ |
| | Fixed and Quarterly Floating | | months in | 0.01 = | Fluctuation = | |
| | Payments (LIBOR). Actual/360 | | the March | variable | 0.0025 = | |
| | Day Count Convention. Rate | | quarterly | dollars | variable | |
| | Setting Dates coincide with | | cycle. | | dollars | |
| | Eurodollar Expiration Dates. | | | | | |
| | Cash Flow dates coincide with | | | | | |
| | Eurodollar Value Dates. Cash | | | | | |
| | Settled. | | | | | |
| 3 Yr | IMM Swap Future − Annual | $333K | Two | Point Size = | Minimum | ″ |
| | Fixed and Quarterly Floating | | months in | 0.01 = | Fluctuation = | |
| | Payments (LIBOR). Actual/360 | | the March | variable | 0.0025 = | |
| | Day Count Convention. Rate | | quarterly | dollars | variable | |
| | Setting Dates coincide with | | cycle. | | dollars | |
| | Eurodollar Expiration Dates. | | | | | |
| | Cash Flow dates coincide with | | | | | |
| | Eurodollar Value Dates. Cash | | | | | |
| | Settled. | | | | | |
| 4 Yr | IMM Swap Future − Annual | $250K | Two | Point Size = | Minimum | ″ |
| | Fixed and Quarterly Floating | | months in | 0.01 = | Fluctuation = | |
| | Payments (LIBOR). Actual/360 | | the March | variable | 0.0025 = | |
| | Day Count Convention. Rate | | quarterly | dollars | variable | |
| | Setting Dates coincide with | | cycle. | | dollars | |
| | Eurodollar Expiration Dates. | | | | | |
| | Cash Flow dates coincide with | | | | | |
| | Eurodollar Value Dates. Cash | | | | | |
| | Settled. | | | | | |
| 5 Yr | IMM Swap Future − Annual | $200K | Two | Point Size = | Minimum | ″ |
| | Fixed and Quarterly Floating | | months in | 0.01 = | Fluctuation = | |
| | Payments (LIBOR). Actual/360 | | the March | variable | 0.0025 = | |
| | Day Count Convention. Rate | | quarterly | dollars | variable | |
| | Setting Dates coincide with | | cycle. | | dollars | |
| | Eurodollar Expiration Dates. | | | | | |
| | Cash Flow dates coincide with | | | | | |
| | Eurodollar Value Dates. Cash | | | | | |
| | Settled. | | | | | |

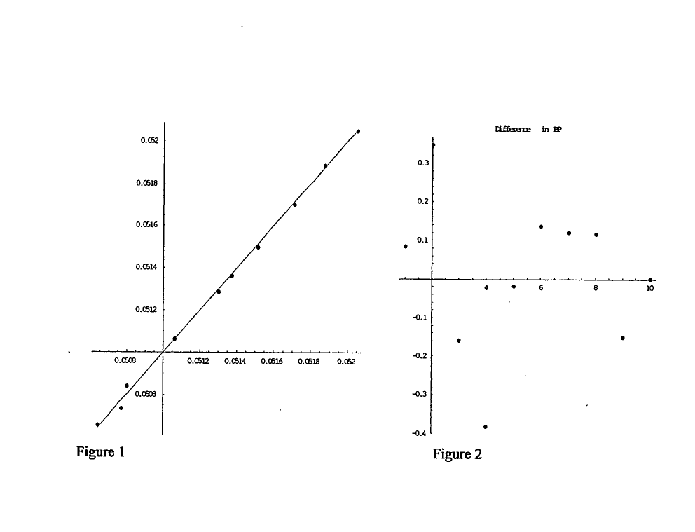

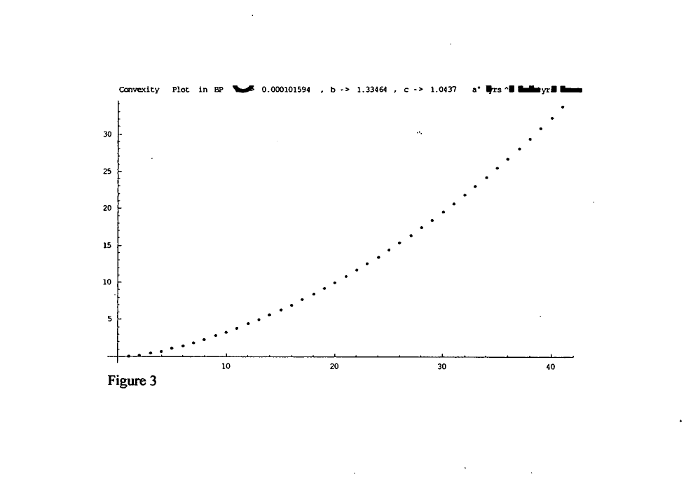

Referring now to FIG. 1, a scatter plot, with a particular type of swap contract term structure, is seen where the x coordinate is a swap coupon generated by fitting the convexity adjustment vector according to a functional form, and the y coordinate is the market observed swap coupon. In one embodiment, the functional form can be defined as convexity(years)=a*(b^{years})*(years^{c}). The black line is provided as a reference and is created by the equation y=x. The black line represents the match between the observed coupon and the generated coupon. FIG. 2 shows the horizontal distance from the scatter plot points to the y=x line. The difference in basis points between the observed coupon and generated coupon is shown by the y coordinate, and the x coordinate is the swap maturity in years. FIG. 3 shows a plot of the \vec{cvx} vector resulting from the assumed functional form fit. In this example, the function is a*(b^{years})*(years^{c}) where {a,b,c} are optimized parameters in the fit and years represents the Actual/360 years to expiration of the Eurodollar futures contracts. The x coordinate is the contract position representation of the Eurodollar futures and the y coordinate is the basis point convexity adjustment to the futures price.

Tables 2 and 3 below show an example spread sheet used to evaluate one embodiment of the IMM swap valuation in accordance with the present invention. The spreadsheet contains information about each cash flow, net cash flow, and discounted net cash flow. It is further shown that there is a coupon, C, that allows the sum of net discounted cash flows to equal zero:

TABLE 2
An Evaluation of One Embodiment of the IMM Swap Valuation Method of the Present Invention.
IMM Swap Cash Flows

| | | | | |
|---|---|---|---|---|
| Forward | Maturity | Notional | 100,000,000 | |
| 35 | 1855 | p fixed/float | 4 | |
| | | MaturityYears | 5 | |
| | | Start Contract | 1 | 35 |
| | | End Contract | 21 | 1855 |

| 100*(DFfwd − DFi) | Ti | DF(p*i) · Ti | 100*C | Fixed | Floating | Net |
|---|---|---|---|---|---|---|
| Sum[Fi*ti*DFi) | Act/360 | Sum Product | Coupon | Cash Flows | Cash Flows | Cash Flows |
| 1.034 | | | | 0 | 1,049,378 | −1,049,378 |
| 2.307 | | | | 0 | 1,308,487 | −1,308,487 |
| 3.500 | | | | 0 | 1,241,266 | −1,241,266 |
| 4.679 | 1.0111 | 0.959700788 | | 5,056,115 | 1,242,145 | 3,813,970 |
| 5.837 | | | | 0 | 1,235,332 | −1,235,332 |
| 6.974 | | | | 0 | 1,227,122 | −1,227,122 |
| 8.096 | | | | 0 | 1,226,382 | −1,226,382 |
| 9.207 | 1.0111 | 1.873617947 | | 5,056,115 | 1,229,316 | 3,826,799 |
| 10.310 | | | | 0 | 1,235,268 | −1,235,268 |
| 11.401 | | | | 0 | 1,236,643 | −1,236,643 |
| 12.481 | | | | 0 | 1,239,779 | −1,239,779 |
| 13.551 | 1.0111 | 2.74361264 | | 5,056,115 | 1,244,041 | 3,812,074 |
| 14.614 | | | | 0 | 1,251,307 | −1,251,307 |
| 15.666 | | | | 0 | 1,253,295 | −1,253,295 |
| 16.710 | | | | 0 | 1,258,935 | −1,258,935 |
| 17.745 | 1.0111 | 3.571205198 | | 5,056,115 | 1,264,418 | 3,791,697 |
| 18.773 | | | | 0 | 1,272,242 | −1,272,242 |
| 19.789 | | | | 0 | 1,273,469 | −1,273,469 |
| 20.796 | | | | 0 | 1,277,069 | −1,277,069 |
| 21.792 | 1.0111 | 4.357876941 | 5.0006 | 5,056,115 | 1,280,488 | 3,775,627 |
| | | | | Sum of | Sum of | Sum of |
| | | | C | Fixed | Floating | Net |
| | | | Coupon | Cash Flows | Cash Flows | Cash Flows |
| | | | 5.0006 | 25,280,576 | 24,846,381 | 434,195 |

TABLE 3
An Evaluation of One Embodiment of the IMM Swap Valuation
Method of the Present Invention
Nov. 16, 2005 Current Date
Dec. 21, 2005 Effective Date
Dec. 15, 2010 End Date

| Discounted | 100*Fi | Calendar | ti | Contract | DFi |
|---|---|---|---|---|---|
| Net Cash flow | Cvx Adj Fut Rate | Days | Act/360 | Tickers | Discount Factors |
| | | 35 | | EDZ5 | 0.995945 |
| −1,034,269 | 4.49733 | 119 | 0.233 | EDH6 | 0.985602 |
| −1,272,990 | 4.80669 | 217 | 0.272 | EDM6 | 0.972872 |
| −1,192,787 | 4.91050 | 308 | 0.253 | EDU6 | 0.960945 |
| 3,620,048 | 4.91398 | 399 | 0.253 | EDZ6 | 0.949155 |
| −1,158,213 | 4.88703 | 490 | 0.253 | EDH7 | 0.937572 |
| −1,136,568 | 4.85455 | 581 | 0.253 | EDM7 | 0.926207 |
| −1,122,122 | 4.85162 | 672 | 0.253 | EDU7 | 0.914986 |
| 3,458,945 | 4.86323 | 763 | 0.253 | EDZ7 | 0.903874 |
| −1,102,903 | 4.88677 | 854 | 0.253 | EDH8 | 0.892845 |
| −1,090,643 | 4.89221 | 945 | 0.253 | EDM8 | 0.881939 |
| −1,080,019 | 4.90462 | 1036 | 0.253 | EDU8 | 0.871138 |
| 3,280,040 | 4.92148 | 1127 | 0.253 | EDZ8 | 0.860434 |
| −1,063,361 | 4.95022 | 1218 | 0.253 | EDH9 | 0.849801 |
| −1,051,868 | 4.95809 | 1309 | 0.253 | EDM9 | 0.839282 |
| −1,043,465 | 4.98040 | 1400 | 0.253 | EDU9 | 0.828847 |
| 3,103,497 | 5.00209 | 1491 | 0.253 | EDZ9 | 0.818498 |
| −1,028,246 | 5.03305 | 1582 | 0.253 | EDH0 | 0.808216 |
| −1,016,296 | 5.03790 | 1673 | 0.253 | EDM0 | 0.798053 |
| −1,006,317 | 5.05214 | 1764 | 0.253 | EDU0 | 0.787990 |
| 2,937,540 | 5.06567 | 1855 | 0.253 | EDZ0 | 0.778027 |
| Sum of Discounted | | | | | |
| Net Cash Flows | | | | | |
| 0 | | | | | |

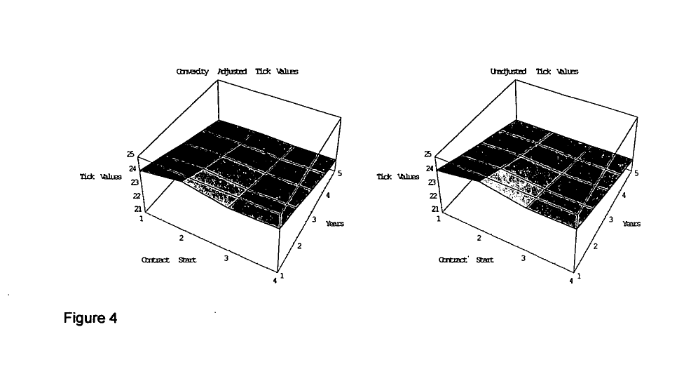

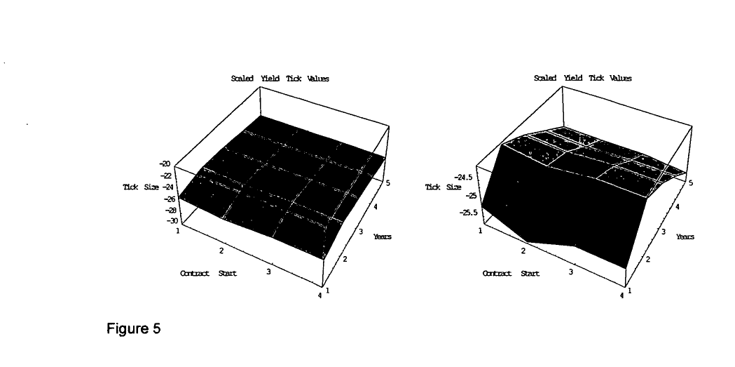

Table 4 and FIG. 4 show the year adjusted (the basic notional principal amount has been divided by the years integer to create smaller notional sizes for longer maturity contracts) tick values for EWM swaps with discount curves calculated from convexity adjusted futures prices and unadjusted futures prices. In addition, this figure compares the tick grids by simple (raw) differences and percent differences. Surface plots of the convexity adjusted and unadjusted tick size matrices are presented to better visually illustrate the results. All matrices are indexed by {x,y}={contract start position,years}, where {1,1} is the upper left corner position and {4,5} is the lower right corner position in the matrix:

TABLE 4
Notional/Year Adjusted Tick Values for IMM
Swaps with Discount Curves Calculated From Futures Prices,
and Convexity Adjusted Futures Prices.

cvxAdjustedTickValues:

$( \begin{matrix}24.0902 & 24.5084 & 24.0653 & 24.0688 \\ 23.5156 & 23.7036 & 23.4902 & 23.4921 \\ 22.9565 & 23.0674 & 22.929 & 22.9291 \\ 22.4109 & 22.4826 & 22.3807 & 22.3788 \\ 21.8781 & 21.9262 & 21.8454 & 21.9138\end{matrix} )$

unadjustedTickValues:

$( \begin{matrix}24.0898 & 24.5077 & 24.0641 & 24.0672 \\ 23.5141 & 23.7014 & 23.4872 & 23.4881 \\ 22.9529 & 23.0625 & 22.9228 & 22.9212 \\ 22.4036 & 22.4735 & 22.3695 & 22.3652 \\ 21.8653 & 21.9108 & 21.8271 & 21.8919\end{matrix} )$

rawDifferences:

$( \begin{matrix}- 0.000393943 & - 0.000726152 & - 0.00113824 & - 0.00167202 \\ - 0.0014893 & - 0.00216961 & - 0.0030036 & - 0.00167202 \\ - 0.00367393 & - 0.0048404 & - 0.00623314 & - 0.00785743 \\ - 0.00731376 & - 0.00910627 & - 0.0112023 & - 0.0135916 \\ - 0.0127747 & - 0.0153359 & - 0.018285 & - 0.0218965\end{matrix} )$

percentDifferences:

$( \begin{matrix}- 0.00163531 & - 0.00296296 & - 0.00473004 & - 0.00694733 \\ - 0.00633366 & - 0.00915392 & - 0.0127882 & - 0.0170757 \\ - 0.0160064 & - 0.0209882 & - 0.0271919 & - 0.0342802 \\ - 0.0326455 & - 0.04052 & - 0.0500787 & - 0.0607712 \\ - 0.0584245 & - 0.0699924 & - 0.0837722 & - 0.100021\end{matrix} )$

Tables 5 and 6, and FIG. 5, show tick values obtained from the 100-yield contract definition. The parameters used in the function that creates the contract specifications are altered in the scaled matrix; and the function can output tick sizes close to $25 per tick as an example of the method. Surface plots of the scaled matrix are presented to visually illustrate the results. Matrix values are taken across start contract (CTstart) and maturity (years) as in previous Tables. Table 5 shows the unscaled yield tick sizes or the dollar change for a one tick change in yield. The values vary according to the function and parameters below:

TABLE 5
Tick Values Obtained from the
100-Yield Contract Definition

Function[{coupon→.06, notionalVar→1000000,
basisPointsPerTick→.25, yearScale→years, start→CTstart,
yield→.O5},

{years,1,5},
{CTstart,1,4}]
$( \begin{matrix}- 1.37746 & - 1.39876 & - 1.37453 & - 1.37487 \\ - 1.99999 & - 2.00653 & - 1.99591 & - 1.99605 \\ - 2.58107 & - 2.58147 & - 2.5754 & - 2.57509 \\ - 3.12207 & - 3.11836 & - 3.11437 & - 3.11342 \\ - 3.62437 & - 3.61734 & - 3.61435 & - 3.6331\end{matrix} )$

Scaled yield tick sizes or the dollar change for a one tick change in yield. The values vary according to the function and parameters below:

TABLE 6
Tick Values Obtained from the
100-Yield Contract Definition

Function[{coupon→.055, notionalVar→5000000,
basisPointsPerTick→1, yearScale→years\ddot{ }1.6, start→CTstart,
yield→.05},

{years,1,5},
{CTstart,1,4}]
$( \begin{matrix}- 25.2205 & - 25.7055 & - 25.2205 & - 25.2205 \\ - 24.1666 & - 24.3266 & - 24.1666 & - 24.1666 \\ - 24.4651 & - 24.5487 & - 24.4651 & - 24.4651 \\ - 24.923 & - 24.9758 & - 24.923 & - 24.923 \\ - 25.3397 & - 25.3766 & - 25.3397 & - 25.4916\end{matrix} )$

Tables 7 and 8 present an example of the “hedge ratio” decomposition method. Table 7 shows the partial sensitivities of a particular swap contract, here a plain “vanilla” with two years maturity observed on a particular date and with a forward effective date, to changes in the forward rate associated with each futures contract, denoted by the contract ticker. Table 8 aggregates the results from Table 7 and incorporates a notional principal amount of 100 million to demonstrate the required number of futures necessary to approximately hedge the first order changes in the net present value of the swap contract with respect to any of the forward rates denoted by the futures tickers.

TABLE 7
An Example of the “Hedge Ratio” Decomposition Method

| | Zhx1 | Zhx2 | Zhx3 | Zhx4 | Zhx5 | Zhx6 | Zhx7 | Zhx8 | Zhx9 |
|---|---|---|---|---|---|---|---|---|---|
| Stub | −0.226357 | −0.223511 | −0.221155 | −0.218642 | −0.216178 | −0.213778 | −0.211352 | −0.208949 | −0.206585 |
| edz2005 f1 | −0.228637 | −0.225763 | −0.223383 | −0.220845 | −0.218356 | −0.215932 | −0.213481 | −0.211055 | −0.208666 |
| edh2006 f2 | −0.00633829 | −0.262862 | −0.26009 | −0.257135 | −0.254238 | −0.251415 | −0.248562 | −0.245736 | −0.242955 |
| edm2006 f3 | 0 | −0.0199403 | −0.241693 | −0.238947 | −0.236254 | −0.233632 | −0.23098 | −0.228354 | −0.22577 |
| edu2006 f4 | 0 | 0 | −0.00531177 | −0.238939 | −0.236247 | −0.233624 | −0.230972 | −0.228347 | −0.225763 |
| edz2006 f5 | 0 | 0 | 0 | −0.00787688 | −0.23624 | −0.233617 | −0.230965 | −0.22834 | −0.225756 |
| edh2007 f6 | 0 | 0 | 0 | 0 | −0.00778848 | −0.233628 | −0.230976 | −0.22835 | −0.225766 |
| edm2007 f7 | 0 | 0 | 0 | 0 | 0 | −0.00513466 | −0.230975 | −0.22835 | −0.225766 |
| edu2007 f8 | 0 | 0 | 0 | 0 | 0 | 0 | −0.00761446 | −0.228346 | −0.225762 |
| edz2007 f9 | 0 | 0 | 0 | 0 | 0 | 0 | 0 | −0.0100364 | −0.225745 |
| edh2008 f10 | 0 | 0 | 0 | 0 | 0 | 0 | 0 | 0 | −0.00992288 |

Table 8 indicates the number of futures contracts (in decimal form) needed to closely hedge the first order movements of the swap in Table 7.

TABLE 8
An Example of the “Hedge Ratio” Decomposition Method

| | |
|---|---|
| Stub | −0.959778 |
| edz2005 f1 | −0.969449 |
| edh2006 f2 | −103.975 |
| edm2006 f3 | −97.9199 |
| edu2006 f4 | −96.7383 |
| edz2006 f5 | −95.6486 |
| edh2007 f6 | −94.5663 |
| edm2007 f7 | −93.4797 |
| edu2007 f8 | −92.4278 |
| edz2007 f9 | −91.3821 |
| edh2008 f10 | −4.01477 |

While the invention has been described with specific embodiments, other alternatives, modifications, and variations will be apparent to those skilled in the art. Accordingly, it will be intended to include all such alternatives, modifications and variations set forth within the spirit and scope of the appended claims.

What is claimed is:

1. A financial instrument comprising:
a standardized contract that obligates a buyer and a seller to settle the contract at a price determined for an effective date; and
at least one traded instrument that is utilized to determine at least one rate that is used to determine the price of the contract.

2. The financial instrument of claim 1 further wherein the contract is traded through an exchange and cleared by a clearinghouse that guarantees payment to the buyer of an amount owed to the buyer from the seller as a result of the contract, the clearinghouse further guarantees payment to the seller of an amount owed to the seller from the buyer as a result of the contract.

3. The financial instrument of claim 2 further wherein the exchange comprises a futures exchange and the contract is traded through the futures exchange in an exchange-based trading system.

4. The financial instrument of claim 2 further wherein the exchange comprises a clearing agent and the contract is traded through the clearing agent in an over-the-counter trading system.

5. The financial instrument of claim 1 further wherein the contract is traded through the International Money Market, a division of the Chicago Mercantile Exchange.

6. The financial instrument of claim 1 further wherein trade data is transmitted between the buyer and an exchange and between the seller and an exchange via a system of networked computers, trade data including information relating to the contract.

7. The financial instrument of claim 6 further wherein the system of networked computers comprises a wide area network and trade data is transmitted between the buyer and the exchange and between the seller and the exchange via the wide area network, trade data including information relating to the contract.

8. The financial instrument of claim 7 further wherein the wide area network comprises the Internet and trade data is transmitted between the buyer and the exchange and between the seller and the exchange via the Internet, the trade data including information relating to the contract.

9. The financial instrument of claim 1 further wherein the at least one traded instrument that is utilized to determine the at least one rate that is used to determine the price of the contract is traded on an exchange.

10. The financial instrument of claim 1 further wherein the at least one traded instrument that is utilized to determine the at least one rate that is used to determine the price of the contract is traded over the counter.

11. The financial instrument of claim 1 further including an Actual/360 day count convention with longer-term fixed cash flows and shorter-term floating interest-rate cash flows.

12. The financial instrument of claim 1 further wherein the effective date is in the future.

13. The financial instrument of claim 1 further wherein the financial instrument comprises a future on a benchmark short term interest rate.

14. The financial instrument of claim 1 further wherein the standardized contract is traded through a forum selected from the group comprising a designated contract market, a derivatives transaction execution facility, an electronic trading facility, an exempt board of trade, and any future such facility.

15. A method of trading comprising:
trading a standardized contract that obligates a buyer and a seller to settle the contract based on a price determined for an effective date;
clearing the standardized contract by a clearinghouse;
the clearinghouse guaranteeing payment to the buyer of an amount owed to the buyer from the seller as a result of the contract;
the clearinghouse further guaranteeing payment to the seller of an amount owed to the seller from the buyer as a result of the contract; and
utilizing at least one traded instrument to determine at least one rate that is used to determine the price of the contract.

16. The method of claim 15 further including trading the standardized contract through an exchange.

17. The method of claim 16 further including trading the standardized contract through a futures exchange and the trading step comprises trading the contract through the futures exchange in an exchange-based trading system.

18. The method of claim 16 further wherein the exchange comprises a clearing agent and the trading step comprises trading the contract through the clearing agent in an over-the-counter trading system.

19. The method of claim 15 further including trading the standardized contract through the International Money Market, a division of the Chicago Mercantile Exchange.

20. The method of claim 15 further wherein the trading step comprises transmitting trade data between the buyer and an exchange and between the seller and an exchange via a system of networked computers, trade data including information relating to the contract.

21. The method of claim 20 further wherein the system of networked computers comprises a wide area network and the transmitting step comprises transmitting trade data between the buyer and the exchange and between the seller and the exchange via the wide area network, trade data including information relating to the contract.

22. The method of claim 21 further wherein the wide area network comprises the Internet and the transmitting step comprises transmitting trade data between the buyer and the exchange and between the seller and the exchange via the Internet, the trade data including information relating to the contract.

23. The method of claim 15 further including trading the at least one traded instrument that is utilized to determine the at least one rate that is used to determine the price of the contract on an exchange.

24. The method of claim 15 further including trading the at least one traded instrument that is utilized to determine the at least one rate that is used to determine the price of the contract over the counter.

25. The method of claim 15 further including providing an Actual360 day count convention with longer-term fixed cash flows and shorter-term floating interest-rate cash flows.

26. The method of claim 15 further wherein the effective date is in the future.

27. The method of claim 15 further including trading an interest rate derivative contract.

28. The method of claim 27 further including trading a future on a benchmark short term interest rate.

29. The method of claim 15 further wherein trading the standardized contract through a forum selected from the group comprising a designated contract market, a derivatives transaction execution facility, an electronic trading facility, an exempt board of trade, and any future such facility.

30. A financial instrument comprising an interest rate derivative that provides an Actual/360 day count convention with longer-term fixed cash flows and shorter-term floating interest-rate cash flows.

31. The financial instrument of claim 30 further wherein fixed and floating day counts are Actual/360, so the number of years between certain floating cash flows is consistent with the number of years between corresponding fixed cash flows that occur on the same dates.

32. The financial instrument of claim 30 further wherein an Actual/360 day count convention allows a market participant to gain swap exposure without having to leave the money market valuation, risk, and hedging framework.

33. The financial instrument of claim 30 further wherein the shorter-term floating interest-rate is selected from the group comprising LIBOR, EURIBOR, TIBOR, ISDAFIX, and combinations thereof.

34. The financial instrument of claim 30 further wherein the longer-term fixed cash flows are annual fixed cash flows and the shorter-term floating interest-rate cash flows are quarterly.

35. The financial instrument of claim 30 further wherein the interest rate derivative is traded on an electronic exchange.

36. The financial instrument of claim 30 further wherein the interest rate derivative is traded over the counter.

37. The financial instrument of claim 30 further wherein the interest rate derivative is traded by open outcry.

38. The financial instrument of claim 30 further wherein the interest rate derivative is exchanged cleared.

39. The financial instrument of claim 30 further wherein the interest rate derivative is cleared over the counter.

40. The financial instrument of claim 30 further wherein the interest rate derivative is cash settled.

41. The financial instrument of claim 30 further wherein the interest rate derivative is deliverable.

42. The financial instrument of claim 30 further wherein the interest rate derivative is rolled.

43. The financial instrument of claim 30 further wherein the interest rate derivative is converted to a weighted strip selected from the group comprising Eurodollar futures, options, and combinations thereof.

44. The financial instrument of claim 30 further wherein the interest rate derivative comprises a swap.

45. The financial instrument of claim 30 further wherein the interest rate derivative is traded through a forum selected from the group comprising a designated contract market, a derivatives transaction execution facility, an electronic trading facility, an exempt board of trade, and any future such facility.

46. A financial instrument comprising an interest rate derivative that has an absence of date mismatches between tools used to create a discount curve and the cash flow dates of the interest rate derivative.

47. The financial instrument of claim 46 further wherein the tools used to create the discount curve comprise bootstrapped Eurodollar strips.

48. The financial instrument of claim 46 further wherein the interest rate derivative is traded on an electronic exchange.

49. The financial instrument of claim 46 further wherein the interest rate derivative is traded over the counter.

50. The financial instrument of claim 46 further wherein the interest rate derivative is traded by open outcry.

51. The financial instrument of claim 46 further wherein the interest rate derivative is exchanged cleared.

52. The financial instrument of claim 46 further wherein the interest rate derivative is cleared over the counter.

53. The financial instrument of claim 46 further wherein the interest rate derivative is cash settled.

54. The financial instrument of claim 46 further wherein the interest rate derivative is deliverable.

55. The financial instrument of claim 46 further wherein the interest rate derivative is rolled.

56. The financial instrument of claim 46 further wherein the interest rate derivative is converted to a weighted strip selected from the group comprising Eurodollar futures, options, and combinations thereof.

57. The financial instrument of claim 46 further wherein the interest rate derivative comprises a swap.

58. The financial instrument of claim 46 further wherein the interest rate derivative is traded through a forum selected from the group comprising a designated contract market, a derivatives transaction execution facility, an electronic trading facility, an exempt board of trade, and any future such facility.

59. A financial instrument comprising an interest rate derivative that matches risk buckets with a combination of financial instrument pieces by maturity.

60. The financial instrument of claim 59 further wherein the interest rate derivative matches risk buckets with short end interest futures pieces by maturity, and forward yields can be bootstrapped from an interest rate curve.

61. The financial instrument of claim 60 further wherein the interest rate derivative matches risk buckets with Eurodollar pieces by maturity, and forward yields can be bootstrapped from the Eurodollar curve.

62. The financial instrument of claim 59 further wherein future bond price can be equal to the future value of notional cash flows.

63. The financial instrument of claim 62 further wherein future bond price (FBP) comprises:
FBP=100%*(DFₙ+ΣC*Tᵢ*DFᵢ)
where C comprises the coupon; Tᵢ comprises the Actual/360 years corresponding to each coupon payment period; and each DFᵢ comprises the future discount factor corresponding to the time period from the beginning of the interest rate derivative agreement to the payment date of each coupon.

64. The financial instrument of claim 62 further wherein coupon (C) comprises:
$$C = \frac{( {\sum }_{j = 1}^{n} {F}_{j} * {DF}_{j} * {t}_{j} )}{( {\sum }_{i = 1}^{n / p} {DF}_{( p * i )} * {T}_{i} )}$$
where n comprises the number of total time periods in an interest rate derivative; fᵢ comprises 100 minus futures price spanning time (j-1) to time (j); DFⱼ comprises the future discount factor corresponding to the time period from the beginning of the interest rate derivative agreement to the payment date (j) of each coupon; tᵢ comprises the number of years between futures maturity date (j-1) and date (j); p comprises the ratio of the fixed to floating payment periods; and Tᵢ comprises the number of years between fixed cash flow date (i-1) and date (i).

65. The financial instrument of claim 62 further wherein coupon (C) comprises:
$$C = \frac{1 - {DF}_{n}}{( {\sum }_{i = 1}^{n / p} {DF}_{( p * i )} * {T}_{i} )}$$

66. The financial instrument of claim 59 further wherein a method of applying discount factors is selected from the group comprising bootstrapping method, bond price method, coupon method, and yield method.

67. The financial instrument of claim 59 further wherein the interest rate derivative is traded on an electronic exchange.

68. The financial instrument of claim 59 further wherein the interest rate derivative is traded over the counter.

69. The financial instrument of claim 59 further wherein the interest rate derivative is traded by open outcry.

70. The financial instrument of claim 59 further wherein the interest rate derivative is exchanged cleared.

71. The financial instrument of claim 59 further wherein the interest rate derivative is cleared over the counter.

72. The financial instrument of claim 59 further wherein the interest rate derivative is cash settled.

73. The financial instrument of claim 59 further wherein the interest rate derivative is deliverable.

74. The financial instrument of claim 59 further wherein the interest rate derivative is rolled.

75. The financial instrument of claim 59 further wherein the interest rate derivative is converted to a weighted strip selected from the group comprising Eurodollar futures, options, and combinations thereof.

76. The financial instrument of claim 59 further wherein the interest rate derivative comprises a swap.

77. The financial instrument of claim 59 further wherein interest rate derivative contract is traded through a forum selected from the group comprising a designated contract market, a derivatives transaction execution facility, an electronic trading facility, an exempt board of trade, and any future such facility.

78. An interest rate derivative contract comprising:
a combination of fixed and floating payments where any fixed rate is determined at the trading of the contract and any floating rate is determined at some time in the future; and
at least one traded instrument that is utilized to determine at least one rate that is used to determine the interest rate derivative value.

79. The interest rate derivative contract of claim 78 further wherein the at least one traded instrument that is utilized to determine the at least one rate that is used to determine the interest rate derivative future value is traded on an exchange.

80. The interest rate derivative contract of claim 78 further wherein the at least one traded instrument that is utilized to determine the at least one rate that is used to determine the interest rate derivative future value is traded over the counter.

81. The interest rate derivative contract of claim 78 further including an Actual/360 day count convention with longer-term fixed cash flows and shorter-term floating interest-rate cash flows.

82. The interest rate derivative contract of claim 78 further wherein the effective date is in the future.

83. The interest rate derivative contract of claim 78 further including a shorter-term floating interest-rate selected from the group comprising LIBOR, EURIBOR, TIBOR, ISDAFIX, and combinations thereof.

84. The interest rate derivative contract of claim 78 further wherein the interest rate derivative contract is traded on an electronic exchange.

85. The interest rate derivative contract of claim 78 further wherein the interest rate derivative contract is traded over the counter.

86. The interest rate derivative contract of claim 78 further wherein the interest rate derivative contract is traded by open outcry.

87. The interest rate derivative contract of claim 78 further wherein the interest rate derivative contract is exchanged cleared.

88. The interest rate derivative contract of claim 78 further wherein the interest rate derivative contract is cleared over the counter.

89. The interest rate derivative contract of claim 78 further wherein the interest rate derivative contract is cash settled.

90. The interest rate derivative contract of claim 78 further wherein the interest rate derivative contract is deliverable.

91. The interest rate derivative contract of claim 78 further wherein the interest rate derivative contract is rolled.

92. The interest rate derivative contract of claim 78 further wherein the interest rate derivative contract is converted to a weighted strip selected from the group comprising Eurodollar futures, options, and combinations thereof.

93. The interest rate derivative contract of claim 78 further wherein the interest rate derivative contract comprises a swap.

94. The interest rate derivative contract of claim 78 further wherein the interest rate derivative contract is traded through a forum selected from the group comprising a designated contract market, a derivatives transaction execution facility, an electronic trading facility, an exempt board of trade, and any future such facility

95. A financial instrument comprising an instrument price that indicates the state of a market and, when the financial instrument is traded, counterparties are liable for a proxy of the instrument.

96. The financial instrument of claim 95 further wherein the financial instrument comprises an interest rate derivative.

97. The financial instrument of claim 96 further wherein the interest rate derivative comprises an interest rate swap.

98. The financial instrument of claim 95 further wherein the financial instrument comprises a future on a benchmark short term interest rate.

99. The financial instrument of claim 95 further wherein the proxy comprises a weighted strip selected from the group comprising Eurodollar futures, options, and combinations thereof.

100. The financial instrument of claim 95 further wherein counterparties are liable to each other for a proxy of the instrument.

101. The financial instrument of claim 95 further wherein counterparties are liable to a clearing party for a proxy of the instrument.

102. The financial instrument of claim 95 further wherein proxy comprises a weighted strip of Eurodollars.

103. The financial instrument of claim 95 further wherein when the financial instrument is cleared, counterparties are liable for a proxy of the instrument.

104. The financial instrument of claim 95 further wherein the financial instrument is traded through a forum selected from the group comprising a designated contract market, a derivatives transaction execution facility, an electronic trading facility, an exempt board of trade, and any future such facility.

105. A financial instrument comprising a value of a minimum price fluctuation of a contract based on that instrument being variable and the value of the minimum price fluctuation of the contract is determined by at least one other instrument.

106. The financial instrument of claim 105 further wherein the value of the minimum price fluctuation is continuously variable.

107. The financial instrument of claim 105 further wherein the value of the minimum price fluctuation is discretely variable.

108. The financial instrument of claim 105 further wherein the value of the minimum price fluctuation of the contract is determined by the shape of a discount curve.

109. The financial instrument of claim 108 further wherein the value of the minimum price fluctuation of the contract is determined by the shape of a discount curve derived from at least one other financial instrument.

110. The financial instrument of claim 109 further wherein the value of the minimum price fluctuation of the contract is determined by the shape of a discount curve derived from convexity adjusted Eurodollar prices.

111. The financial instrument of claim 105 further wherein the financial instrument comprises an interest rate derivative contract.

112. The financial instrument of claim 111 further wherein the interest rate derivative contract comprises a future on a benchmark short term interest rate.

113. The financial instrument of claim 105 further wherein the financial instrument is traded through a forum selected from the group comprising a designated contract market, a derivatives transaction execution facility, an electronic trading facility, an exempt board of trade, and any future such facility.

114. A financial instrument where the minimum price fluctuation of the contract based on that instrument is variable.

115. The financial instrument of claim 114 further wherein the value of the minimum price fluctuation of the contract is determined by at least one other instrument.

116. The financial instrument of claim 114 further wherein the minimum price fluctuation is continuously variable.

117. The financial instrument of claim 114 further wherein the minimum price fluctuation is discretely variable.

118. The financial instrument of claim 114 further wherein the minimum price fluctuation of the contract is determined by the shape of a discount curve.

119. The financial instrument of claim 118 further wherein the minimum price fluctuation of the contract is determined by the shape of a discount curve derived from at least one other financial instrument.

120. The financial instrument of claim 119 further wherein the minimum price fluctuation of the contract is determined by the shape of a discount curve derived from convexity adjusted Eurodollar prices.

121. The financial instrument of claim 114 further wherein the financial instrument comprises an interest rate derivative contract.

122. The financial instrument of claim 121 further wherein the interest rate derivative contract comprises a future on a benchmark short term interest rate.

123. The financial instrument of claim 114 further wherein the financial instrument is traded through a forum selected from the group comprising a designated contract market, a derivatives transaction execution facility, an electronic trading facility, an exempt board of trade, and any future such facility.

124. A financial instrument comprising a value of a minimum price fluctuation of a contract based on that instrument being fixed and a minimum price fluctuation value of the contract significantly deviates from the actual fluctuation value of the instrument such that the contract does not function as a proxy to the instrument.

125. The financial instrument of claim 124 further wherein the contract does not settle on a one-to-one basis to the instrument.

126. The financial instrument of claim 124 further wherein the minimum price fluctuation value of the contract deviates from the actual fluctuation value of the instrument more than about seven percent.

127. The financial instrument of claim 124 further wherein the minimum price fluctuation value of the contract deviates from the actual fluctuation value of the instrument more than about ten percent.

128. The financial instrument of claim 124 further wherein the value of the minimum price fluctuation is continuously variable.

129. The financial instrument of claim 124 further wherein the value of the minimum price fluctuation is discretely variable.

130. The financial instrument of claim 124 further wherein the financial instrument comprises an interest rate derivative contract.

131. The financial instrument of claim 130 further wherein the interest rate derivative contract comprises a future on a benchmark short term interest rate.

132. The financial instrument of claim 124 further wherein the financial instrument is traded through a forum selected from the group comprising a designated contract market, a derivatives transaction execution facility, an electronic trading facility, an exempt board of trade, and any future such facility.

133. A financial instrument comprising a value of a minimum price fluctuation of a contract based on that instrument being fixed and a minimum price fluctuation value of the contract significantly deviates from the actual fluctuation value of the instrument such that the contract does not settle on a one-to-one basis to the instrument.

134. The financial instrument of claim 133 further wherein the contract does not function as a proxy to the instrument.

135. The financial instrument of claim 133 further wherein notionals are not altered to determine the minimum price fluctuation of a contract.

136. The financial instrument of claim 133 further the minimum price fluctuation value of the contract deviates from the actual fluctuation value of the instrument more than about seven percent.

137. The financial instrument of claim 133 further wherein the value of the minimum price fluctuation is continuously variable.

138. The financial instrument of claim 133 further wherein the value of the minimum price fluctuation is discretely variable.

139. The financial instrument of claim 133 further wherein the financial instrument comprises an interest rate derivative.

140. The financial instrument of claim 139 further wherein the interest rate derivative comprises a future on a benchmark short term interest rate.

141. The financial instrument of claim 133 further wherein the financial instrument is traded through a forum selected from the group comprising a designated contract market, a derivatives transaction execution facility, an electronic trading facility, an exempt board of trade, and any future such facility.

142. A method of implying convexity adjustments used to convert futures rates to forward rates using at least one observable rate comprising fitting the convexity adjustment vector according to a functional form.

143. The method of implying convexity adjustments used to convert future rates to forward rates using at least one observable rate of claim 142 further wherein the convexity adjustments are derived from the following (solving for \vec{cvx}):
$$C = \frac{{\sum }_{j = 1}^{n} ( ( {f}_{j} + {cvx}_{j} ) * {t}_{j} * {\prod }_{k = 1}^{j} \frac{1}{1 + ( {f}_{k} + {cvx}_{k} ) * {t}_{k}} )}{{\sum }_{i = 1}^{n / p} ( {T}_{i} * {\prod }_{i = 1}^{p * i} \frac{1}{1 + ( {f}_{k} + {cvx}_{k} ) * {t}_{k}} )}$$

144. The method of implying convexity adjustments used to convert future rates to forward rates using at least one observable rate of claim 142 further wherein the financial instrument comprises an interest rate derivative contract.

145. The method of implying convexity adjustments used to convert future rates to forward rates using at least one observable rate of claim 144 further wherein the interest rate derivative comprises a future on a benchmark short term interest rate.

146. The method of implying convexity adjustments used to convert future rates to forward rates using at least one observable rate of claim 142 further wherein the futures are Eurodollar futures.

147. The method of implying convexity adjustments used to convert future rates to forward rates using at least one observable rate of claim 142 further wherein the forwards are three month LIBOR forward rates.

148. The method of implying convexity adjustments used to convert future rates to forward rates using at least one observable rate of claim 142 further wherein the observable rates are consensus settled.

149. The method of implying convexity adjustments used to convert future rates to forward rates using at least one observable rate of claim 142 further wherein the observable rates are ISDAFIX swap rates.

150. The method of implying convexity adjustments used to convert future rates to forward rates using at least one observable rate of claim 142 further wherein interest rate derivative rates are a linear combination of discount factors, and the discount factors are a function of forward rates.

151. The method of implying convexity adjustments used to convert future rates to forward rates using at least one observable rate of claim 142 further wherein multiple observed prices are used in conjunction to fit the convexity adjustment vector.

152. The method of implying convexity adjustments used to convert future rates to forward rates using at least one observable rate of claim 142 further wherein multiple observed prices are used simultaneously to fit the convexity adjustment vector.

153. The method of implying convexity adjustments used to convert future rates to forward rates using at least one observable rate of claim 142 further wherein the functional form is convexity(years)=a*(b^{years})*(years^{c}).

154. The method of implying convexity adjustments used to convert futures rates to forward rates using at least one observable rate of claim 142 further comprising creating a financial instrument whose value is determined in part by fitting the convexity adjustment vector according to a functional form.

155. The method of implying convexity adjustments used to convert futures rates to forward rates using at least one observable rate of claim 154 further comprising creating a contract whose value is determined in part by fitting the convexity adjustment vector according to a functional form.

156. The method of implying convexity adjustments used to convert futures rates to forward rates using at least one observable rate of claim 154 further comprising settling the financial instrument into a proxy.

157. The method of implying convexity adjustments used to convert future rates to forward rates using at least one observable rate of claim 142 further wherein the convexity adjustments are derived from the following:
$${C}_{m} = \frac{1 {\hat{DF}}_{( m * p )}}{( {\sum }_{i = 1}^{m * p} {T}_{i} * {\hat{DF}}_{i} )}$$
where \hat{D}Fᵢ is a discount factor interpolated or extrapolated from the discount factor curve generating function
$${DF}_{n} = {\prod }_{j = 1}^{n} \frac{1}{1 + ( {f}_{j} + {cvx}_{j} ) * {t}_{j}} .$$
